(19) United States
(12) Patent Application Publication
(10) Pub. No.: US 2026/0286120 A1
(43) Pub. Date: Sep. 24, 2026

(54) AN ARTIFICIAL LEATHER BASED ON CROSSLINKED OBC AND A METHOD FOR PREPARING THE SAME

(71) Applicant: Dow Global Technologies LLC, Midland, MI (US)

(72) Inventors: Yunfeng Yang, Shanghai (CN); Xuejun Liu, Shanghai (CN); Andong Liu, Shanghai (CN); Yabin Sun, Shanghai (CN); Haiyang Yu, Shanghai (CN); Ming Ming, Shanghai (CN)

(73) Assignee: Dow Chemical (China) Investment Company Limited, Shanghai (CN)

(21) Appl. No.: 19/168,999

(22) PCT Filed: Oct. 10, 2023
(86) PCT No.: PCT/CN2023/123707

§ 371 Date: Sep. 25, 2025

(51) Int. Cl. C08L 53/00; B32B 3/30; B32B 5/02; B32B 5/18; B32B 5/24; B32B 27/06; B32B 27/12; B32B 27/32; C08J 3/28

(52) U.S. Cl. CPC C08L 53/00; B32B 3/30; B32B 5/02; B32B 5/18; B32B 5/245; B32B 27/065; B32B 27/12; B32B 27/32; C08J 3/28; B32B 2255/10; B32B 2255/24; B32B 2266/0278; B32B 2270/00; B32B 2307/306; B32B 2307/54; B32B 2307/72; C08J 2353/00; C08L 2312/08

(57) ABSTRACT

Providing an artificial leather comprising a multi-layer structure comprising a top skin layer and a bottom fabric layer, wherein the top skin layer comprises a polymer blend comprising at least 10 wt % and up to 100 wt % of an olefin block copolymer, based on the total weight of the top skin layer, wherein the polymer blend is crosslinked and the crosslinked polymer blend has a gel % of at least 5% by weight by a hot xylene extraction method.

### FIELD OF THE INVENTION

The present disclosure relates to an artificial leather based on crosslinked OBC and a method for preparing the same.

### INTRODUCTION

Polyolefin elastomer (POE, including olefin block copolymer (OBC), random POE, and the like) based artificial leather is thought to be an eco-friendly and sustainable artificial leather product. Compared with incumbent polyvinyl chloride (PVC) leather, POE leather is halogen free and also free of phthalate plasticizers. Compared with another incumbent conventional polyurethane (PU) leather, no solvent (e.g. DMF, harmful) is needed during the POE leather manufacturing process. Thus, POE leather production is greener, which brings minimal water/air/soil pollution. Besides, POE leather has advantage in terms of low VOC and low odor. From the point of view of performance, POE has excellent weatherability and low temperature flexibility, and no issue of hydrolysis and yellowing. Besides, POE leather can more easily meet the lightweight trend in luggage/bag, shoe and auto applications because the density of POE is much lower than PVC (by ~40%) and PU (by ~25%). It is believed that POE leather will be a promising product to replace PVC and PU leather in several applications.

Hand-feel/softness is the most critical requirement for an artificial leather. A soft POE resin is therefore desired in most cases. However, the soft POE resin usually delivers a poor room temperature Bally flex resistance, a critical characterization of durability and mechanical fatigue during cyclic flexural stress, much poorer compared with PU and PVC. On the other hand, conventional random soft POE has poor heat resistance. OBC has high melting point blocky structure, which provides OBC in pellet form with higher softness than conventional random soft POE (limited to mass issue). Therefore, using OBC with high softness can make leather with better hand-feel than random POE. However, the soft OBC also delivers poor Bally flex resistance. It is still difficult to develop an artificial leather based on soft POE, which demonstrates improved Bally flex resistance and heat resistance of surface grain after embossing.

Therefore, there still remains a constant demand for an artificial leather which demonstrates both improved Bally flex resistance and heat resistance of surface grain after embossing.

After persistent exploration, we have surprisingly found that the Bally flex resistance of soft OBC could be significantly improved by a certain level of crosslinking. In addition, the crosslinked soft OBC has much better heat resistance than crosslinked random POE with similar softness.

### SUMMARY OF THE INVENTION

In a first aspect of the present disclosure, the present disclosure provides an artificial leather comprising a multi-layer structure; the multi-layer structure comprising of a top skin layer and a bottom fabric layer, wherein the top skin layer comprises a polymer blend comprising at least 10 wt % and up to 100 wt % of an olefin block copolymer, based on the total weight of the top skin layer, wherein the polymer blend is crosslinked and the crosslinked polymer blend has a gel % of at least 5% by weight by a hot xylene extraction method.

In a second aspect of the present disclosure, the present disclosure provides a method for preparing an artificial leather comprising a multi-layer structure; the method comprising of
preparing a top skin layer and a bottom fabric layer, wherein the top skin layer comprises a polymer blend comprising at least 10 wt % of an olefin block copolymer, based on the total weight of the top skin layer, laminating the top skin layer and the bottom fabric layer together; and crosslinking the polymer blend, so that the polymer blend is crosslinked and the crosslinked polymer blend has a gel % of at least 5% by weight by a hot xylene extraction method.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

The numerical ranges disclosed herein include all values from, and including, the lower and upper value. For ranges containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.). Unless stated to the contrary, implicit from the context, or customary in the art, all parts and percentages are based on weight and all test methods are current as of the filing date of this disclosure.

As disclosed herein, the term “composition”, “formulation” or “mixture” refers to a physical blend of different components, which is obtained by mixing simply different components by a physical means. The sum of the percentages by weight of each component in a composition is 100 wt %, based on the total weight of the composition.

As disclosed herein, “and/or” means “and, or as an alternative”. All ranges include endpoints unless otherwise indicated.

The term “polymer” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer” as used herein, refers to polymer prepared by the polymerization of at least two different types of monomers. The term interpolymer thus includes the term copolymer (employed to refer to polymers prepared from two different types of monomers) and polymers prepared from more than two different types of monomers.

The term “substantially free of” means the content of a certain substance is less than 1 wt %, less than 0.5 wt %, less than 0.2 wt %, less than 0.1 wt %, less than 100 ppm or 0 wt % based on the total weight of the corresponding composition or layer (such as the top skin layer or the middle foam layer) comprising the stated substance.

The present disclosure provides an artificial leather comprising a multi-layer structure comprising a top skin layer and a bottom fabric layer, wherein the top skin layer comprises a polymer blend comprising at least 10 wt % of an olefin block copolymer, based on the total weight of the top skin layer, wherein the polymer blend is crosslinked and the crosslinked polymer blend has a gel % of at least 5% by weight by a hot xylene extraction method.

Preferably, the top skin layer is not foamed.

Preferably, the bottom fabric layer comprises a flexible, polymeric material.

Preferably, the multi-layer structure further comprises a foam layer between the top skin layer and the bottom fabric layer.

Preferably, the top skin layer is substantially free of propylene/alpha-olefin copolymer.

### Top Skin Layer

The top skin layer comprises a polymer blend comprising a crosslinked olefin block copolymer and/or a crosslinked random copolymer. The polymer blend comprises at least 10 wt %, preferably at least 20 wt %, at least 30 wt %, at least 40 wt %, at least 50 wt %, at least 60 wt %, at least 70 wt %, at least 80 wt %, at least 90 wt %, or 100 wt % of a crosslinked olefin block copolymer based on the total weight of the top skin layer. It may comprise a crosslinked ethylene/α-olefin random copolymer at a content of no greater than 90 wt %, no greater than 80 wt %, no greater than 70 wt %, no greater than 60 wt %, no greater than 50 wt %, no greater than 40 wt %, no greater than 30 wt %, no greater than 20 wt %, no greater than 10 wt %, or 0 wt %. The top skin layer can also comprise one or more optional additives such as processing aids (e.g., zinc stearate), extenders, blocking agents, pigments and/or dyes, antioxidants, UV-stabilizers and/or absorbers, oils, flame retardants, fillers (such as talc, calcium carbonate), and the like.

Preferably, the top skin layer is substantially free of propylene/alpha-olefin copolymer.

### Foam Layer

The foam layer (also called a middle foam layer) comprises at least one of (i) an olefin block copolymer, and (ii) an ethylene/α-olefin random copolymer. The foam layer can also comprise the gas from the decomposed blowing agent or the gas originally from the decomposed blowing agent and has already been partially or totally replaced by air and any unreacted, residual blowing agent. The middle foam layer can also comprise one or more optional additives such as processing aids (e.g., zinc stearate), extenders, blocking agents, pigments and/or dyes, antioxidants, UV-stabilizers and/or absorbers, oils, flame retardants, fillers (such as talc, calcium carbonate), and the like.

The middle foam layer can be compositionally the same as the top skin layer except for the gas and by-products attributable to the foaming process.

The middle foam layer typically comprises at least 10 wt %, or at least 20 wt %, more typically at least 40 wt %, more typically at least 50 wt % and even more typically at least 60 wt % of an olefin block copolymer. The maximum amount of olefin block copolymer in the middle foam layer typically does not exceed 90 wt %, more typically does not exceed 80 wt % and even more typically does not exceed 70 wt %, based on the total weight of the foam layer.

Preferably, the middle foam layer is substantially free of propylene/alpha-olefin copolymer.

Generally, the blowing agent is incorporated into the copolymer composition which is to be foamed in amounts ranging from 0.1 to 30, phr, preferably 1 to 20, phr and more preferably 2 to 10, phr. The blowing agent typically is incorporated into the melt stream under a pressure which is sufficient to inhibit its activation, that is, to inhibit foaming of the melt stream during the incorporation of the blowing agent and subsequent processing of the composition until the stream is ready to be foamed.

If present at all, the total amount of optional additives present in the foam layer typically is greater than zero, more typically at least 1 and even more typically at least 2, phr. If present at all, the total amount of optional additives in the foam layer typically does not exceed 10, phr, more typically does not exceed 7, phr and even more typically does not exceed 5, phr.

If present at all, the total amount of optional filler present in the foam layer typically is greater than zero, more typically at least 5 wt % and even more typically at least 10 wt %. If present at all, the total amount of optional fillers in the foam layer typically does not exceed 60 wt %, more typically does not exceed 40 wt % and even more typically does not exceed 20 wt %.

The foam layer is typically prepared by blending or compounding the individual components with one another in any conventional mixing apparatus, e.g., Brabender™ internal mixer, Haake™ internal mixer, Banbury™ kneader or any suitable extruder, under conditions and for a time that produces an at least substantially homogeneous mixture, calendering the mixture using conventional equipment and conditions to form a sheet, and then heat laminating the sheet to the top skin layer and/or bottom fabric layers using conventional lamination equipment and conditions. The foam layer is typically not subjected to foaming conditions until after it is laminated to at least one of the top skin layer and bottom fabric layers, preferably not until it is laminated to both layers (if a three- or more layer structure). The foaming conditions are such that very fine and regular cells are formed throughout the layer. Typical foaming conditions include an oven temperature of 220° C. or more and an oven residence time of 60-180 seconds. The foam expansion ratio is based on the ratio of expanded thickness to original (non-expanded) thickness (herein referred to as the thickness ratio), and it is typically 1.5 to 4, more typically 2 to 3.

### Bottom Fabric Layer

The bottom fabric layer comprises a flexible, polymeric material which can be woven, nonwoven, knitted, plained, spunbond, etc., and it can comprise natural and/or synthetic fiber. In one embodiment, the fabric layer is a nonwoven, polymeric, spunbond material of a weight of 100-500 g/m², more typically of 150-400 g/m² and even more typically of 200-350 g/m². Fabrics that can be used in the practice of the present disclosure include, but are not limited to, cotton, silk and various synthetics based on polyolefins (e.g., polyethylene, polypropylene, etc.), nylon, polyester, polyurethane (e.g., a spandex material), and the like. In one embodiment, the preferred fabric is prepared from polyester, polyethylene or polypropylene. The fabric can be subjected to a pre-lamination treatment, e.g., corona surface treatment, impregnation, etc., or not, and the foam or top skin layer is ultimately heat laminated to it.

### Ethylene/α-Olefin Multi-Block Interpolymer

The term “ethylene/α-olefin multi-block interpolymer”, also called “ethylene/α-olefin multi-block copolymer” or “olefin block copolymer (OBC)” as used herein, refers to an interpolymer that includes ethylene and one or more copolymerizable α-olefin comonomers in polymerized form, characterized by multiple blocks or segments of two or more (preferably three or more) polymerized monomer units, the blocks or segments differing in chemical or physical properties. Specifically, this term refers to a polymer comprising two or more (preferably three or more) chemically distinct regions or segments (referred to as “blocks”) joined in a linear manner, that is, a polymer comprising chemically differentiated units which are joined (covalently bonded) end-to-end with respect to polymerized functionality, rather than in pendent or grafted fashion. The blocks differ in the amount or type of comonomer incorporated therein, the density, the amount of crystallinity, the type of crystallinity (e.g., polyethylene versus polypropylene), the crystallite size attributable to a polymer of such composition, the type or degree of tacticity (isotactic or syndiotactic), region-regularity or region-irregularity, the amount of branching, including long chain branching or hyper-branching, the homogeneity, and/or any other chemical or physical property. The block copolymers are characterized by unique distributions of both polymer polydispersity (PDI or Mw/Mn) and block length distribution, e.g., based on the effect of the use of a shuttling agent(s) in combination with catalyst systems. Non-limiting examples of the olefin block copolymers of the present disclosure, as well as the processes for preparing the same, are disclosed in U.S. Pat. Nos. 7,858,706 B2, 8,198,374 B2, 8,318,864 B2, 8,609,779 B2, 8,710,143 B2, 8,785,551 B2, 9,243,090 B2, and US20230058913 which are all incorporated herein by reference in their entirety.

Ethylene/α-olefin multi-block interpolymers are characterized by multiple blocks or segments of two or more polymerized monomer units, differing in chemical or physical properties.

In some embodiments, the multi-block copolymers can be represented by the following formula: (AB)n, where n is at least 1, preferably an integer greater than 1, such as 2, 3, 4, 5, 10, 15, 20, 30, 40, 50, 60, 70, 80, 90, 100, or higher. Here, “A” represents a hard block or segment, and “B” represents a soft block or segment. Preferably the A segments and the B segments are linked in a substantially linear fashion, as opposed to a substantially branched or substantially star-shaped fashion. In other embodiments, the A segments and the B segments are randomly distributed along the polymer chain. In other words, for example, the block copolymers usually do not have a structure as follows: AAA-AA-BBB-BB. In still other embodiments, the block copolymers do not usually have a third type of block or segment, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

The olefin block copolymers, in general, are produced via a chain shuttling process, such as, for example, described in U.S. Pat. No. 7,858,706, which is herein incorporated by reference. Some chain shuttling agents and related information are listed in Col. 16, line 39, through Col. 19, line 44. Some catalysts are described in Col. 19, line 45, through Col. 46, line 19, and some co-catalysts in Col. 46, line 20, through Col. 51 line 28. Some process features are described in Col 51, line 29, through Col. 54, line 56. See also the following: U.S. Pat. Nos. 7,608,668; 7,893,166; and U.S. Pat. No. 7,947,793 as well as US Patent Publication 2010/0197880. See also U.S. Pat. No. 9,243,173.

Preferably, ethylene comprises the majority mole fraction of the whole ethylene/α-olefin multi-block copolymer, i.e., ethylene comprises at least 40 wt % of the whole ethylene/α-olefin multi-block copolymer. More preferably, ethylene comprises at least 50 wt %, at least 60 wt %, at least 70 wt %, or at least 80 wt %, with the substantial remainder of the whole ethylene/α-olefin multi-block interpolymer comprising the C4-C8 α-olefin comonomer, preferably, the C4-C8 α-olefin comonomer may be selected from butene, pentene, hexene, pentene, heptane, and octene, preferably 1-butene, 1-hexene, and 1-octene. In an embodiment, the ethylene/α-olefin multi-block interpolymer contains from 40 wt %, 50 wt %, or 60 wt %, or 65 wt % to 80 wt %, or 85 wt %, or 90 wt % ethylene. For many ethylene/octene multi-block interpolymers, the composition comprises an ethylene content greater than 80 wt % of the whole ethylene/octene multi-block interpolymer and an octene content of from 10 wt % to 15 wt %, or from 15 wt % to 20 wt % of the whole ethylene/octene multi-block interpolymer.

The ethylene/α-olefin multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of monomers other than ethylene) is greater than 5 wt %, or greater than 8 wt %, or greater than 10 wt %, or greater than 15 wt %, based on the weight of the polymer. In an embodiment, the comonomer content in the soft segments is greater than 20 wt %, or greater than 25 wt %, or greater than 30 wt %, or greater than 35 wt %, or greater than 40 wt %, or greater than 45 wt %, or greater than 50 wt %, or greater than 60 wt % and can be up to 100 wt %.

The soft segments can be present in an ethylene/α-olefin multi-block interpolymer from 1 wt %, or 5 wt %, or 10 wt %, or 15 wt %, or 20 wt %, or 25 wt %, or 30 wt %, or 35 wt %, or 40 wt %, or 45 wt % to 55 wt %, or 60 wt %, or 65 wt %, or 70 wt %, or 75 wt %, or 80 wt %, or 85 wt %, or 90 wt %, or 95 wt %, or 99 wt % of the total weight of the ethylene/α-olefin multi-block interpolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, the disclosure of which is incorporated by reference herein in its entirety. In particular, hard and soft segment weight percentages and comonomer content may be determined as described in column 57 to column 63 of U.S. Pat. No. 7,608,668.

The polymer blend in the top skin layer is crosslinked and the crosslinked polymer blend has a gel % of at least 5% by weight by a hot xylene extraction method, preferably at least 10% by weight by a hot xylene extraction method, more preferably at least 15% by weight by a hot xylene extraction method, even more preferably at least 20% by weight by a hot xylene extraction method. It is found by the inventors that the Bally flex resistance of soft OBC may be significantly improved if the polymer blend is crosslinked to have a gel % of >5%. Preferably, the crosslinked polymer blend has a gel % from about 5% to about 100% by weight by a hot xylene extraction method, preferably from about 10% to about 100% by weight by a hot xylene extraction method, more preferably from about 15% to about 99% by weight by a hot xylene extraction method, even more preferably from about 20% to about 90% by weight by a hot xylene extraction method.

The polymer blend may be crosslinked by any crosslinking technology known in the art. Preferably, the polymer blend in the top skin layer and/or foam layer may be crosslinked by, but not limited to, E-beam curing, UV curing, peroxide curing, silane curing and the like.

In an embodiment, the ethylene/α-olefin multi-block copolymer is produced in a continuous process and possesses a polydispersity index (Mw/Mn) from 1.7 to 3.5, or from 1.8 to 3, or from 1.8 to 2.5, or from 1.8 to 2.2. When produced in a batch or semi-batch process, the ethylene/α-olefin multi-block copolymer possesses Mw/Mn from 1.0 to 3.5, or from 1.3 to 3, or from 1.4 to 2.5, or from 1.4 to 2.

Nonlimiting examples of suitable ethylene/α-olefin multi-block copolymer are disclosed in U.S. Pat. No. 7,608,668, the entire content of which is incorporated by reference herein.

In an embodiment, the ethylene/α-olefin multi-block copolymer consists of only (i) ethylene and (ii) a C4-C8 α-olefin.

In an embodiment, the ethylene/α-olefin multi-block copolymer has hard segments and soft segments, is styrene-free, consists of only (i) ethylene and (ii) a C4-C8 α-olefin, and is defined as having a Mw/Mn from 1.7 to 3.5.

In an embodiment, the ethylene/α-olefin multi-block interpolymer has a density of between about 0.850 g/cc and about 0.890 g/cc, preferably between about 0.855 g/cc and 0.880 g/cc, more preferably between about 0.858 g/cc and about 0.870 g/cc, even more preferably between about 0.860 g/cc and about 0.866 g/cc.

Preferably, the ethylene/α-olefin multi-block interpolymer used in the present disclosure has a MI of not greater than about 20 g/10 min at 190° C./2.16 kg, preferably not greater than about 18 g/10 min at 190° C./2.16 kg, more preferably not greater than about 17 g/10 min at 190° C./2.16 kg, more preferably not greater than about 16 g/10 min at 190° C./2.16 kg, even more preferably not greater than about 15 g/10 min at 190° C./2.16 kg or not greater than 12 g/10 min at 190° C./2.16 kg, Alternatively, the ethylene/α-olefin multi-block interpolymer used in the present disclosure has a MI from about 0.1 g/10 min at 190° C./2.16 kg to about 20 g/10 min at 190° C./2.16 kg, preferably about 0.5 g/10 min at 190° C./2.16 kg to about 18 g/10 min at 190° C./2.16 kg, more preferably about 1 g/10 min at 190° C./2.16 kg to about 16 g/10 min at 190° C./2.16 kg, even more preferably about 5 g/10 min at 190° C./2.16 kg to about 15 g/10 min at 190° C./2.16 kg.

Preferably, the ethylene/α-olefin multi-block interpolymer used in the present disclosure has a melting point of 100-130° C., more preferably 105-125° C., more preferably 110-120° C.

Suitable ethylene/α-olefin multi-block interpolymer can be INFUSE™ from Dow, such as INFUSE™ 9107, INFUSE™ 9500, INFUSE™ 9507, INFUSE™ 9807 or OBC 1 prepared according to IE 6 of US20230058913.

### Ethylene/α-Olefin Random Copolymer

An ethylene/α-olefin random copolymer (also called random POE) is an ethylene/propylene random copolymer or an ethylene/C4-C8 α-olefin random copolymer. In an embodiment, the ethylene/α-olefin copolymer is an ethylene/C4-C8 α-olefin copolymer. The ethylene/C4-C8 α-olefin copolymer is composed of, or otherwise consists of, ethylene and one copolymerizable C4-C8 α-olefin comonomer in polymerized form. The C4-C8 α-olefin comonomer may be selected from butene, pentene, hexene, heptane, and octene, preferably 1-butene, 1-hexene, and 1-octene.

In an embodiment, the ethylene/α-olefin random copolymer used in the present disclosure has a density of between about 0.850 g/cc and about 0.900 g/cc, preferably between about 0.855 g/cc and 0.895 g/cc, more preferably between about 0.857 g/cc and about 0.890 g/cc, even more preferably between about 0.865 g/cc and about 0.885 g/cc.

Preferably, the ethylene/α-olefin random copolymer used in the present disclosure has a MI of not greater than about 20 g/10 min (at 190° C./2.16 kg), preferably not greater than about 15 g/10 min at 190° C./2.16 kg, more preferably not greater than about 10 g/10 min at 190° C./2.16 kg, more preferably not greater than about 8 g/10 min at 190° C./2.16 kg, even more preferably not greater than about 7 g/10 min at 190° C./2.16 kg or not greater than 6 g/10 min at 190° C./2.16 kg, or not greater than 5 g/10 min at 190° C./2.16 kg. Alternatively, the ethylene/α-olefin random copolymer used in the present disclosure has a MI from about 0.1 g/10 min at 190° C./2.16 kg to about 20 g/10 min at 190° C./2.16 kg, preferably about 0.2 g/10 min at 190° C./2.16 kg to about 15 g/10 min at 190° C./2.16 kg, more preferably about 0.3 g/10 min at 190° C./2.16 kg to about 8 g/10 min at 190° C./2.16 kg, even more preferably about 1 g/10 min at 190° C./2.16 kg to about 5 g/10 min at 190° C./2.16 kg.

Suitable ethylene/α-olefin random copolymer can be ENGAGE™ from Dow, such as ENGAGE™ 8003, ENGAGE™ 8842, ENGAGE™M7447, ENGAGE™ 8150, ENGAGE™ 7467 or POE1 prepared according to Ex 1 of U.S. Pat. No. 11,236,241.

The random copolymer in the top skin layer and/or foam layer may be crosslinked or not by certain technology, such as E-beam curing, UV curing, peroxide curing, silane curing and the like.

### Blowing Agent

Most any of the known blowing agents (also known as foaming or expansion agents) can be employed, including gaseous materials, volatile liquids and chemical agents which decompose into a gas and other byproducts. Representative blowing agents include, without limitation, nitrogen, carbon dioxide, air, methyl chloride, ethyl chloride, pentane, isopentane, perfluoromethane, chlorotrifluoromethane, dichlorodifluoromethane, trichlorofluoromethane, perfluoroethane, 1-chloro-1,1-difluoroethane, chloropentafluoroethane, dichlorotetrafluoroethane, trichlorotrifluoroethane, perfluoropropane, chloroheptafluoropropane, dichlorohexafluoropropane, perfluorobutane, chlorononafluorobutane, perfluorocyclobutane, azodicarbonamide (ADCA), azodiisobutyronitrile, benzenesulfonhydrazide, 4,4-oxybenzene sulfonyl-semicarbazide, p-toluene sulfonyl semicarbazide, barium azodicarboxylate, N,N′-dimethyl-N,N′-dinitrosoterephthalamide, and trihydrazino triazine. Currently, ADCA is a preferred blowing agent.

### Additives

The top skin and middle foam layers may contain additives including but not limited to inorganic fillers, antioxidants, curing agents, cross linking co-agents, boosters and retardants, color masterbatch, processing aids (e.g., zinc stearate), ultraviolet absorbers or stabilizers, antistatic agents, nucleating agents, slip agents, plasticizers, lubricants, viscosity control agents, tackifiers, anti-blocking agents, surfactants, extender oils, acid scavengers, and metal deactivators. Additives can be used in amounts ranging from 0.01 wt % or less to 10 wt % or more based on the weight of the layer.

### Fillers

Examples of fillers include but are not limited to talc, clays, precipitated silica and silicates, fumed silica, calcium carbonate, ground minerals, carbon blacks with arithmetic mean particle sizes larger than 10 nanometers, and the various known flame retardants, particularly halogen-free flame retardants. Fillers can be used in amounts ranging from greater than zero to 50 wt % or more based on the weight of the layer or total composition.

### Preparation Method

### Shaping and Lamination

The present disclosure can be manufactured using the same conventional compression molding (or calendaring) and lamination processes or extrusion and lamination used for PVC-based leathers.

The multi-layer structure may comprise a bottom fabric layer and a top skin layer, the latter optionally coated with a top coating. The top skin layer is made by a compression molding, and then laminated to the bottom fabric layer. The optional PU top coating layer is then applied to the top skin layer of the multi-layer structure.

The multi-layer structure may comprise a bottom fabric layer, a middle foam layer, and a top skin layer, the latter optionally coated with a primer and the primer with a top coating. The top skin layer and middle foam layer of the artificial leather are made by a compression molding, and then laminated to one another and the bottom fabric layer in any convenient order. Foaming is typically conducted after lamination in an oven typically maintained at 220° C. or higher for 60-180 seconds. The optional primer and PU top coating layers are then applied to the top skin layer of the laminated, three-layer structure.

### Crosslinking

The polymer blend of the present discourse is crosslinked. The crosslinking can be performed by a crosslinking agent or by irradiation, for example, peroxide curing or silane curing, or E-beam curing, UV curing.

“Crosslinking” refers to form chemical bonds between different polymer chains to form a network structure. The crosslinking can be performed by any of chemical reaction where above network can be formed. Below are some examples for crosslinking techniques including peroxide, irradiation, moisture curing with silane, hydrosilation, etc.

A crosslinking agent may be used for crosslinking the composition. The crosslinking agent is not particularly limited, as far as the crosslinking agent can crosslink the copolymer. The crosslinking agent used may be a known organic peroxide used for crosslinking a polyethylene-based resin. Examples thereof include the Luperox series compound, such as peroxide 2,5-Bis(tert-butylperoxy)-2,5-dimethylhexane, 1,1-bis(tert-amylperoxy)cyclohexane, the Perbutyl series compound, such as 1,1-bis(tert-butylperoxy)-3,3,5-trimethylcyclohexane, 2,5-dimethyl-2,5-di(tert-butylperoxy) hexane, and di-tert-butyl peroxide, the Perhexyl series compound, such as tert-hexyl peroxybenzoate, and the Perocta series compound, such as 1,1,3,3-tetramethylbutyl peroxy-2-ethylhexanoate. Among these, the Luperox series compound is preferred. These compounds may be used alone or as a combination of two or more kinds thereof. The lower limit of the amount of the crosslinking agent mixed is preferably 0.1 part by weight, and more preferably 0.2 part by weight, per 100 parts by weight of the total weight of the polymer. The upper limit of the amount of the crosslinking agent mixed is preferably 5.0 part by weight, and more preferably 2.5 part by weight, per 100 parts by weight of the total weight of the polymer.

A crosslinking coagent may be used in combination with the crosslinking agent for peroxide crosslinking or radiation crosslinking of polymer blend. Examples of the crosslinking coagent include triallyl cyanurate (TAC), triallyl isocyanurate (TAIC), 1, 2-polybutadiene (1, 2-PBR), sulfur, etc. Among these, triallyl cyanurate (TAC) and triallyl isocyanurate (TAIC) are preferred.

In the case where the amount of the crosslinking agent added is in the range, the polymer is crosslinked to provide a crosslinked polymer having an appropriate gel fraction.

The crosslinking reaction is preferably performed at a temperature that is equal to or higher than the temperature, at which the polymer is softened and the crosslinking agent is substantially decomposed, which is specifically the 1-hour half-life period temperature of the organic peroxide or more and the melting point of the polyethylene-based resin or more. The temperature may be retained for 1 to 200 minutes to perform the crosslinking. For example, the crosslinking reaction is preferably performed at a temperature of 80-220° C., more preferably 120-210° C., even more preferably 150-200° C., or still more preferably 160-180° C.

The crosslinking reaction can also be performed by irradiation, for example, E-beam treatment, at a dose of, such as 30-200 KGy, preferably 40-150 KGy, more preferably 50-120 KGy.

### EXAMPLES

Some embodiments of the invention will now be described in the following Examples, wherein all parts and percentages are by weight unless otherwise specified.

The information of the raw materials used in the examples is listed in the following Table 1:

TABLE 1
Materials/ingredients for blending

| | | Chemical Description, | |
|---|---|---|---|
| Ingredient | Product | Chemical formula, or | |
| Type | Name | Structure | Source |
| Base resin | OBC 1 | HTC olefin block | Prepared |
| | | copolymer, density | according to |
| | | 0.86 g/cm³, MI 5.9 g/10 | IE 6 of |
| | | min (at 190° C./2.16 kg), | US20230058913 |
| | | Shore A ~30 | |
| Base resin | POE 1 | Random POE copolymer, | Prepared |
| | | density 0.857 g/cm³, MI 5 | according to |
| | | g/10 min (at 190° C./ | Ex 1 of |
| | | 2.16 kg), Shore A ~50 | U.S. Pat. No. |
| | | | 11,236,241B2 |
| Base resin | INFUSE ™ | olefin block copolymer, | Dow |
| | 9500 | density 0.877 g/cm³, MI 5 | |
| | | g/10 min (at 190° C./ | |
| | | 2.16 kg), Shore A = 69 | |
| Base resin | INFUSE ™ | olefin block copolymer, | Dow |
| | 9507 | density 0.866 g/cm³, MI 5 | |
| | | g/10 min (at 190° C./ | |
| | | 2.16 kg), Shore A = 60 | |
| Base resin | ENGAGE ™ | Random POE copolymer, | Dow |
| | 7447 | density 0.865 g/cm³, MI 5 | |
| | | g/10 min (at 190° C./ | |
| | | 2.16 kg), Shore A = 64 | |
| Additive | Luperox ™ | Peroxide 2,5-Bis(tert- | Sigma-Aldrich |
| | 101 | butylperoxy)-2,5- | |
| | | dimethylhexane | |
| Additive | TAIC | Triallyl isocyanurate | Fangruida |
| | | | Chemicals |
| | | | Co., Ltd |

### Example I

### Soaking and Mixing

POE resins (100 grams) of Inventive Example 1-8 and Comparative Samples 3-4, 7-8 were first soaked with curatives (Luperox 101+TAIC) in 500 mL fluorinated HDPE bottles on a roller at 40° C. for 24 hours. POE resins of Comparative Samples 1-2, 5, 6 and 9 were not soaked with curatives.

All the resin pellets (50 grams for each sample) with or without soaking were further mixed with 0.25 grams carbon black masterbatch with 50% carbon black in Haake internal mixer at 125° C. and 40 rpm for 5 min. The compound was collected and used for the following leather preparation.

### Compression Molding, Lamination and Crosslinking

The compound from the Haake internal mixer was compression molded into a film in a “15 cm×15 cm×0.5) mm” mold. PTFE films were used to sandwich polymer film. The compound was preheated at 135° C. for 3 minutes, and then degassed (repeated compression at 10 MPa and release, for six times), followed by another 2 minutes at a pressure of 10 MPa and a temperature of 135° C.

After cooling, the upper PTFE film was removed and a fabric (a non-woven fabric) was covered onto the POE film surface. After reheating for 5 min, a pressing was conducted by a roller to increase the adhesion between the molten POE film and fabric. After complete cooling, the lower PTFE film was removed as well and the original leather samples (with fabric and POE layer) were collected for following steps. The leather samples were covered by a PTFE film on the POE layer and then placed in the oven for crosslinking at 180° C. for 15 min. After cooling, the PTFE film was removed and the crosslinked leather samples were collected for following coating. The crosslinked POE layer was cut for gel content measurement.

### Application of PU Top Coating

The POE layer surface was firstly treated by corona (Equipment details: Nanjing Suman Electronics Co., Ltd; PLASMA GENERATOR (High performance computerized plasma and corona discharge experiment generators) to increase surface energy. Set voltage at 180V, current at 1.8 A. The corona brush was moved quickly above the POE layer four times to make sure that a high surface energy (~42 dyn/cm) can be achieved.

After corona treatment, the PU top coating (95% PUD coating (Permute WF-77-307 P77062 from Stahl)+5% curing agent (aliphatic polyisocynate, PERMUTEX® XR-48-920 from Stahl, 5 min stirring for mixing the two) was spread on the POE layer using a wire rod. The coated samples were quickly transferred into the oven at 130° C. for drying and curing for two minutes. The thickness of the resulting top coating is about 10 μm.

### Embossing

The leather samples with a size of 15 cm*15 cm were firstly heated at 150° C. for 1 min. The heated samples were quickly placed onto the embossing mold with POE layer touching the mold surface with a temperature of 38° C. A vacuum was applied for 10 seconds to emboss the grain on the mold to the leather surface. After cooled at room temperature, the surface grain was fixed.

### Example II

### Mixing, Compression Molding and Lamination

POE resins (50 grams) of Inventive Example 9-10 and Comparative Samples 10-11 were mixed with 0.25 grams carbon black masterbatch with 50% carbon black in Haake internal mixer at 125° C. and 40 rpm for 5 min. The compound was collected and used for the following leather preparation.

The compound from the Haake internal mixer was compression molded into a film in a “15 cm×15 cm×0.5) mm” mold. PTFE films were used to sandwich POE film. The compound was preheated at 135° C. for 3 minutes, and then degassed (repeated compression at 10 MPa and release, for six times), followed by another 2 minutes at a pressure of 10 MPa and a temperature of 135° C.

After cooling, the upper PTFE film was removed and a fabric (a non-woven fabric) was covered onto the POE film surface. After reheating for 5 min, a pressing was conducted by a roller to increase the adhesion between the molten POE film and fabric. After complete cooling, the lower PTFE film was removed as well and the original leather samples (with fabric and POE layer) were collected for following coating.

### Application of PU Top Coating

The POE layer surface was firstly treated by corona (Equipment details: Nanjing Suman Electronics Co., Ltd; PLASMA GENERATOR (High performance computerized plasma and corona discharge experiment generators) to increase surface energy. Set voltage at 180V, current at 1.8 A. The corona brush was moved quickly above the POE layer four times to make sure that a high surface energy (~42 dyn/cm) can be achieved.

After corona treatment, the PU top coating (95% PUD coating (Permute WF-77-307 P77062 from Stahl)+5% curing agent (aliphatic polyisocynate, PERMUTEX® XR-48-920 from Stahl), 5 min stirring for mixing the two) was spread on the POE layer using a wire rod. The coated samples were quickly transferred into the oven at 130° C. for drying and curing for two minutes. The thickness of the resulting top coating is about 10 μm.

### Embossing

The leather samples with a size of 15 cm*15 cm were firstly heated at 150° C. for 1 min. The heated samples were quickly placed onto the embossing mold with POE layer touching the mold surface with a temperature of 38° C. A vacuum was applied for 10 seconds to emboss the grain on the mold to the leather surface. After cooled at room temperature, the surface grain was fixed.

### E-Beam Irradiation

The electron beam irradiation was performed on the POE leather samples with PU top coating and embossed surface using an industrial scale E-Beam apparatus. The batch-mode unit has a beam energy of 10.0 MeV. The irradiation dosage is 100 kGy.

### Test and Measurement

Bally flex test: This test method was used to evaluate resistance to cracking of leathers of the Inventive examples and Comparative samples, when subjected to repeated flexing. The test conformed to ASTM D6182-00. The Bally Flexometer conformed to DIN 53351, and operated at a rate of 100 cycles/min. The end of the test was determined by the number of cycles, at which cracking of POE layer surface was observed and was reported as the bally flex result. Two specimens were tested for each composition, and the average value was reported. If no crack/damage was observed after 100k cycles for the two specimens, the result was reported as >100k.

Gel content test: The gel fraction by a hot xylene extraction method can be measured in the following manner. The crosslinked POE skin was cut into small pieces, 3 mm*3 mm. Then around 0.5 g sample (Ws) was sealed in a metal mesh (mesh number is 120) and weighed (Wt1). Then packed sample was transferred into 500 ml flask equipped with condenser and containing 350 ml xylene. After reflux for 5 h, the packed samples were removed from xylene, put into vacuum oven and heated at 120° C. for 2 h under vacuum condition. The sample was taken out and weighed (Wt2). The gel % is calculated by the equation, Gel %=1−(Wt1−Wt2)/Ws*100%.

Heat resistance test: the samples were placed in an 80° C., 100° C. or 120° C. oven. One edge of 10*10 cm specimen was clamped and hanged. The surface grain of the specimen was observed by naked eye after a period of time. If the surface grain was maintained well, the same as the original, a longer time of aging was further carried out.

### Examples and Discussion

The following Table 2-3 showed the constitution and performance parameters of the comparative samples and inventive examples of Example 1 of the present disclosure.

TABLE 2

| Formulation | CS1 | IE1 | IE2 | IE3 | CS2 | CS3 | CS4 | CS5 | IE4 | IE5 |
|---|---|---|---|---|---|---|---|---|---|---|
| OBC 1 | 100 | 100 | 100 | 100 | | | | | | |
| POE 1 | | | | | 100 | 100 | 100 | | | |
| INFUSE ™ 9507 | | | | | | | | 100 | 100 | 100 |
| Luperox 101 | | 0.20 | 0.40 | 0.80 | | 0.32 | 0.64 | | 0.20 | 0.80 |
| TAIC | | 0.20 | 0.40 | 0.80 | | 0.32 | 0.64 | | 0.20 | 0.80 |
| Gel content, % | 0 | 23.1 | 39.7 | 72.4 | 0 | 55.5 | 68.0 | 0 | 21.0 | 36.9 |
| Bally flex failure | 8k | 90k | >100k | >100k | 35k | >100k | >100k | 20k | >100k | >100k |
| cycles | | | | | | | | | | |
| Heat resistance | 100 h | 100 h | 100 h | 100 h | 7 h grain | 28 h | 100 h | 100 h | 100 h | 100 h |
| (80° C.) | ok | ok | ok | ok | disappeared | grain faded | grain faded | ok | ok | ok |

Note*:
ok means surface grain no change after heat aging

TABLE 3

| Formulation | IE6 | IE7 | CS6 | CS7 | CS8 | CS9 | IE8 |
|---|---|---|---|---|---|---|---|
| INFUSE ™9507 | 25 | 50 | | | | | |
| ENGAGE ™ 7447 | 75 | 50 | 100 | 100 | 100 | | |
| INFUSE ™ 9500 | | | | | | 100 | 100 |
| Luperox 101 | 0.40 | 0.40 | | 0.40 | 0.80 | | 0.6 |
| TAIC | 0.40 | 0.40 | | 0.40 | 0.80 | | 0.6 |
| Gel content, % | 60.9 | 52.9 | 0 | 34.7 | 46.6 | 0 | 23.9 |
| Bally flex failure cycles | >100k | >100k | 18k | >100k | >100k | 20k | >100k |
| Heat resistance (80° C.) | 100 h ok | 100 h ok | 7 h grain | 7 h | 28 h grain | 100 h ok | 100 h ok |
| | | | disappeared | grain faded | disappeared | | |

Note*:
ok means surface grain no change after heat aging

The following Table 4 showed the constitution and performance parameters of the comparative samples and inventive examples of Example II of the present disclosure.

TABLE 4

| Formulation | IE9 | CS10 | IE10 | CS11 |
|---|---|---|---|---|
| OBC 1 | 100 | | | |
| POE 1 | | 100 | | |
| INFUSE ™ 9507 | | | 100 | |
| ENGAGE ™ 7447 | | | | 100 |
| E-beam treatment | 100 kGy | 100 kGy | 100 kGy | 100 kGy |
| dosage, kGy | | | | |
| Gel content, % | 51.2 | 52.0 | 51.4 | 34.0 |
| Bally flex cycles | >100k | >100k | >100k | >100k |
| Heat resistance | 168 h, ok | 168 h, grain | 168 h, ok | 168 h, grain |
| @100° C. | | faded | | faded |
| Heat resistance | 168 h, | 120 h, POE | 168 h, ok | 120 h, POE |
| @120° C. | surface | layer | | layer |
| | wrinkled | disappeared, | | disappeared, |
| | to some | totally fused | | totally fused |
| | extent | into fabric | | into fabric |

Note*:
ok means surface grain no change after heat aging

Three OBC resins with relatively high softness (Shore A ~30, 60, 69 with density of 0.86, 0.866 and 0.877 g/cc respectively) were used in the examples. The OBC 1 delivers the lowest hardness, much lower than that of ENGAGE™ POE with lowest density. As shown in Table 2, it is clear that crosslinking significantly improved the Bally flex resistance of OBC (from 10-20k to >100k cycles), even for the softest OBC 1 at a relatively low gel content level ~20% (IE1). On the other hand, the crosslinked OBC based leathers exhibited excellent heat resistance, which was characterized by the good surface grain retention.

However, for the random POE, POE 1 and ENGAGE™ 7447, even after crosslinking, the surface grain disappeared or obviously faded via a short period of aging (as shown in CS3, CS4, CS7 and CS8).

As shown in Table 3, IE6 and IE7 further demonstrates that blending a certain amount (25%, 50%) of OBC with ENGAGE™ can enhance the heat resistance. These two examples also had excellent Bally flex resistance.

These results demonstrated that crosslinked OBC outperformed non-crosslinked OBC and crosslinked random POE in terms of either Bally flex resistance or heat resistance.

As shown in Table 4, it is clear that E-beam crosslinking significantly improved the Bally flex resistance compared with non-crosslinked examples (CS1, CS2, CS5 and CS6). The comparison of IE9 vs. CE10 and IE10 vs. CE11 showed that e-beam crosslinked OBC also had much better heat resistance than e-beam crosslinked conventional random POE.

1. An artificial leather comprising a multi-layer structure comprising a top skin layer and a bottom fabric layer, wherein the top skin layer comprises a polymer blend comprising at least 10 wt % and up to 100 wt % of an olefin block copolymer, based on the total weight of the top skin layer, wherein the polymer blend is crosslinked and the crosslinked polymer blend has a gel % of at least 5% by weight by a hot xylene extraction method.

2. The artificial leather of claim 1, wherein the polymer blend comprises at least 20 wt % of an olefin block copolymer, based on the total weight of the top skin layer.

3. The artificial leather of claim 1, wherein the polymer blend has a gel % of at least 20% by weight by a hot xylene extraction method.

4. The artificial leather of claim 1, wherein the multi-layer structure further comprises a foam layer comprising a crosslinked polymer blend comprising an olefin block copolymer between the top skin layer and the bottom fabric layer.

5. The artificial leather of claim 1, wherein the bottom fabric layer comprises a flexible, polymeric material.

6. The artificial leather of claim 1, wherein the olefin block copolymer has a density of between about 0.850 g/cc and about 0.890 g/cc.

7. The artificial leather of claim 1, wherein the olefin block copolymer has a MI of not greater than about 30 g/10 min at 190° C./2.16 kg.

8. The artificial leather of claim 1, wherein the olefin block copolymer a melting point of 100-130° C.

9. The artificial leather of claim 1, wherein the crosslinked polymer blend is crosslinked by a crosslinking process selected from the group consisting of E-beam curing, UV curing, peroxide curing and silane curing.

10. The artificial leather of claim 1, wherein the crosslinked polymer blend is crosslinked by a peroxide crosslinking agent or by E-beam curing.

11. The artificial leather of claim 1, wherein the olefin block copolymer consists of only (i) ethylene and (ii) a C4-C8 α-olefin.

12. A method for preparing an artificial leather comprising a multi-layer structure of claim 1, comprising
preparing a top skin layer and a bottom fabric layer, wherein the top skin layer comprises a polymer blend comprising at least 10 wt % of an olefin block copolymer,
laminating the top skin layer and the bottom fabric layer together; and
crosslinking the polymer blend, so that the polymer blend is crosslinked and the crosslinked polymer blend has a gel % of at least 5% by weight by a hot xylene extraction method.

13. The method according to claim 12, wherein the crosslinked polymer blend is crosslinked by a crosslinking process selected from the group consisting of E-beam curing, UV curing, peroxide curing and silane curing.
